(19) United States
(12) Patent Application Publication
(10) Pub. No.: US 2016/0034164 A1
(43) Pub. Date: Feb. 4, 2016

(54) Method and Apparatus for a Visual Tool to Selectively Modify Variables

(71) Applicant: Wal-Mart Stores, Inc., Bentonville, AR (US)

(72) Inventors: Donald R. High, Noel, MO (US); Mike Atchley, Springdale, AR (US); Eric E. Welch, Norman, OK (US)

(21) Appl. No.: 14/812,336

(22) Filed: Jul. 29, 2015

Related U.S. Application Data
(60) Provisional application No. 62/030,941, filed on Jul. 30, 2014.

(51) Int. Cl. G06F 3/0484; G06F 17/30

(52) U.S. Cl. CPC G06F 3/04847; G06F 17/30994; G06F 17/30958

(57) ABSTRACT

A control circuit presents, via one or more displays, one or more analytical results as correspond to currently-selected values for two or more variables. That control circuit additionally forms and presents, via at least one such display, a virtual tool for each of the at least two variables, such that a user can selectively vary the variables by movement of the corresponding virtual tool. By one approach the virtual tool presents a visual indication of a present relative value of the corresponding variable (as versus an absolute or specific value for the variable). In such a case, and by one approach, the plurality of virtual tools can each present a visual indication of a present relative value of their corresponding variable using a same relative scale. If desired, the foregoing relative scale can include both positive and negative values.

### RELATED APPLICATION(S)

This application claims the benefit of U.S. Provisional application No. 62/030,941, filed Jul. 30, 2015, which is incorporated by reference in its entirety herein.

### TECHNICAL FIELD

These teachings relate generally to user interfaces and more particularly to graphic user interfaces (GUIs).

### BACKGROUND

Data mining is known in the art and, generally speaking, pertains to discovering patterns in large data sets. Such processing often includes extracting information from a data set and transforming that information into an understandable structure for further use. Such practices often involve database and data management aspects, data preparation, aggregation of values, the execution of statistical models and/or inference considerations, interestingness metrics, complexity considerations, post-processing of discovered structures, and the development of corresponding visualizations.

Notwithstanding the potent capabilities of computers to facilitate such activities, in many cases such automated “number crunching” serves only as a predicate to human analysis and insight. The latter, in turn, often benefits when the human user has the ability to modify one or more variables of interest to thereby develop, test, and/or confirm such insights. Unfortunately, prior art user interfaces that provide such a capability are often relatively nonintuitive and/or require enough cognition on the part of the user as to potentially distract the user from their present analytical train of thought. Worst case, the user's entire purpose in seeking to modify a particular variable can be lost along with the potential benefit of that particular investigation.

### BRIEF DESCRIPTION OF THE DRAWINGS

The above needs are at least partially met through provision of the method and apparatus for a virtual tool to selectively modify variables described in the following detailed description, particularly when studied in conjunction with the drawings, wherein:

FIG. 1 comprises a flow diagram as configured in accordance with various embodiments of these teachings;

FIG. 2 comprises a block diagram as configured in accordance with various embodiments of these teachings;

FIG. 3 comprises a block diagram as configured in accordance with various embodiments of these teachings;

FIG. 4 comprises a plurality of screenshots as configured in accordance with various embodiments of these teachings;

FIG. 5 comprises a plurality of screenshots as configured in accordance with various embodiments of these teachings;

FIG. 6 comprises a plurality of screenshots as configured in accordance with various embodiments of these teachings; and

FIG. 7 comprises a plurality of screenshots as configured in accordance with various embodiments of the invention.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments a control circuit presents, via one or more displays, one or more analytical results as correspond to currently-selected values for two or more variables. That control circuit additionally forms and presents, via at least one such display, a virtual tool for each of the at least two variables, such that a user can selectively vary the variables by movement of the corresponding virtual tool.

By one approach the virtual tool presents a visual indication of a present relative value of the corresponding variable (as versus an absolute or specific value for the variable). In such a case, and by one approach, the plurality of virtual tools can each present a visual indication of a present relative value of their corresponding variable using a same relative scale. If desired, the foregoing relative scale can include both positive and negative values.

These teachings are highly flexible in practice and will accommodate a variety of graphic form factors for the virtual tool. Examples include but are not limited to virtual sliders, virtual rotatable knobs, virtual multi-position toggle switches, and so forth. By another approach, in lieu of the foregoing or in combination therewith, these teachings will accommodate also presenting, via one or more of the aforementioned displays, a numeric value as corresponds to a pre-selected position and/or a selected position of one or more of the virtual tools with respect to the aforementioned relative scale. If desired, such a numeric value can be presented in a presentation area that is separate and apart from the virtual tool itself.

So configured, these teachings provide a relatively intuitive mechanism by which variables as pertain to a particular analytical model (or models) can be modified by a user with little or no training and in a way that supports and even amplifies their present cognitive reasoning rather than diminishing or disrupting their analytical thought process. As a result, these teachings facilitate user interaction in a way that not only simplifies that interaction but that can help the user reach an analytical insight that might not otherwise have been attained due to the frailty of the human thought process.

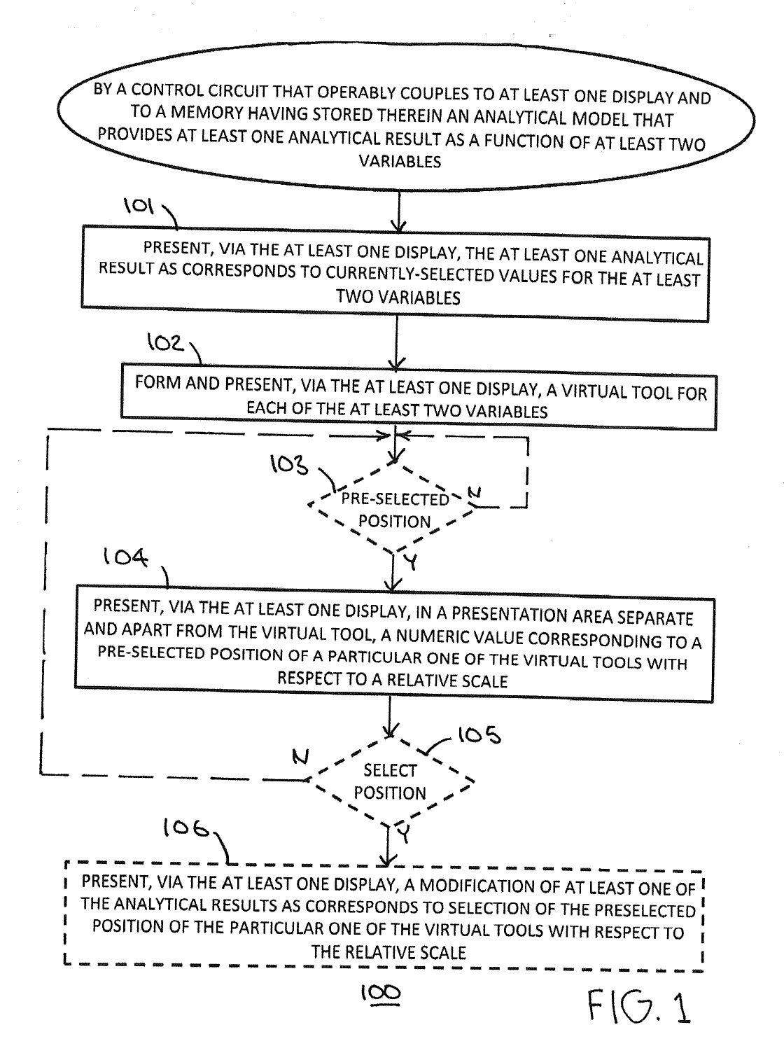

These and other benefits may become clearer upon making a thorough review and study of the following detailed description. Referring now to the drawings, and in particular to FIG. 1, an illustrative process 100 that comports with many of these teachings will now be presented.

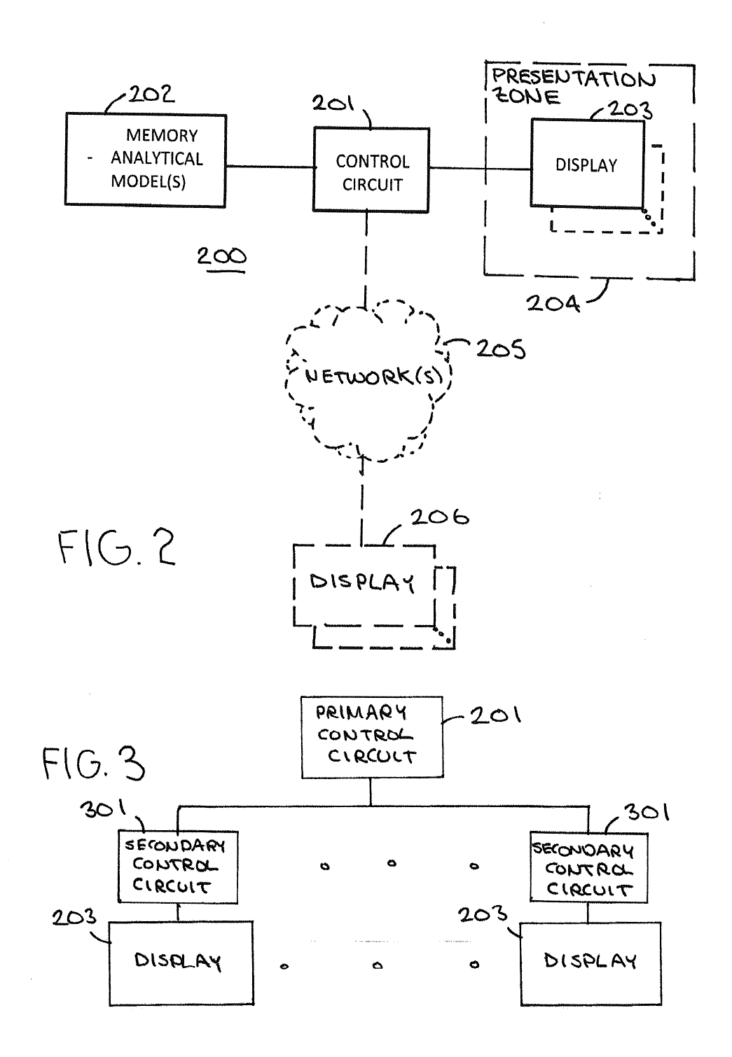

With momentary reference to FIG. 2, for the sake of an illustrative example it will be presumed here that a control circuit 201 carries out this process 100. Such a control circuit 201 can comprise a fixed-purpose hard-wired platform or can comprise a partially or wholly programmable platform. These architectural options are well known and understood in the art and require no further description here. This control circuit 201 is configured (for example, by using corresponding programming as will be well understood by those skilled in the art) to carry out one or more of the steps, actions, and/or functions described herein.

In this illustrative example the enabling system 200 also includes a memory 202 and one or more displays 203 that are all operably coupled to the control circuit 201. The memory 202 may be integral to the control circuit 201 or can be physically discrete (in whole or in part) from the control circuit 201 as desired. This memory 202 can also be local with respect to the control circuit 201 (where, for example, both share a common circuit board, chassis, power supply, and/or housing) or can be partially or wholly remote with respect to the control circuit 201 (where, for example, the memory 202 is physically located in another facility, metropolitan area, or even country as compared to the control circuit 201).

This memory 202 can serve, for example, to non-transitorily store the computer instructions that, when executed by the control circuit 201, cause the control circuit 201 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

In this example the memory 202 also serves to store at least one analytical model. By one approach the analytical model represents a retail sales enterprise (including, for example, one or more publicly-accessible retail sales stores, one or more distribution centers and warehouses, and/or one or more transportation fleets by which goods are moved from and between manufacturers, distribution centers/warehouses, and retail sales stores). The analytical model, when executed, provides at least one analytical result as a function of at least two variables. Example analytical results can include, but are certainly not limited to, sales figures, costs, gross and net income, pricing, and so forth. Such analytical models are known in the art. As the present teachings are not particularly sensitive to any choices in these regards, further elaboration will not be provided here regarding analytical models.

The aforementioned displays 203 can comprise, for example, any of a variety of flat-screen displays as are known in the art as well as front and rear projection systems. The number and size of the displays can vary with the needs of the application setting. As one illustrative example in these regards, the control circuit 201 may operably couple to five large flat screen displays that are all more-or-less horizontally aligned in a shared presentation zone 204 such as a secured room. Various display technologies are known in the art and the present teachings are not particularly sensitive to any particular selections in these regards. Accordingly, and again, further elaboration will not be provided here for the sake of brevity.

If desired, and in combination with the foregoing, these teachings will accommodate optionally coupling the control circuit 201 to one or more networks 205 such as but not limited to one or more private local area networks and/or one or more public networks (such as but not limited to the Internet). So configured, the control circuit 201 can then be operatively coupled via the network(s) 205 to one or more additional displays 206. Those additional displays 206 can be located remotely from the control circuit 201 and the aforementioned presentation zone 204. This reference to “remotely” will be understood to refer to a significant physical separation as when the additional display 206 is physically located in another facility, metropolitan area, or even country as compared to the control circuit 201.

The present teachings are highly flexible with respect to the overall enabling architecture employed. By one approach, and as is suggested by the illustration shown in FIG. 2, the control circuit 201 may directly drive the aforementioned displays 203. These teachings will accommodate, however, having the primary control circuit 201 interact with at least some displays 203 in a less direct fashion. For example, as illustrated in FIG. 3, the control circuit 201 may comprise a primary control circuit that operably couples to secondary control circuits 301 wherein the latter directly control and drive the aforementioned displays 203. Again, these secondary control circuits 301 can comprise any of a variety of hard-wired and/or partially or wholly-programmable platforms as are known in the art.

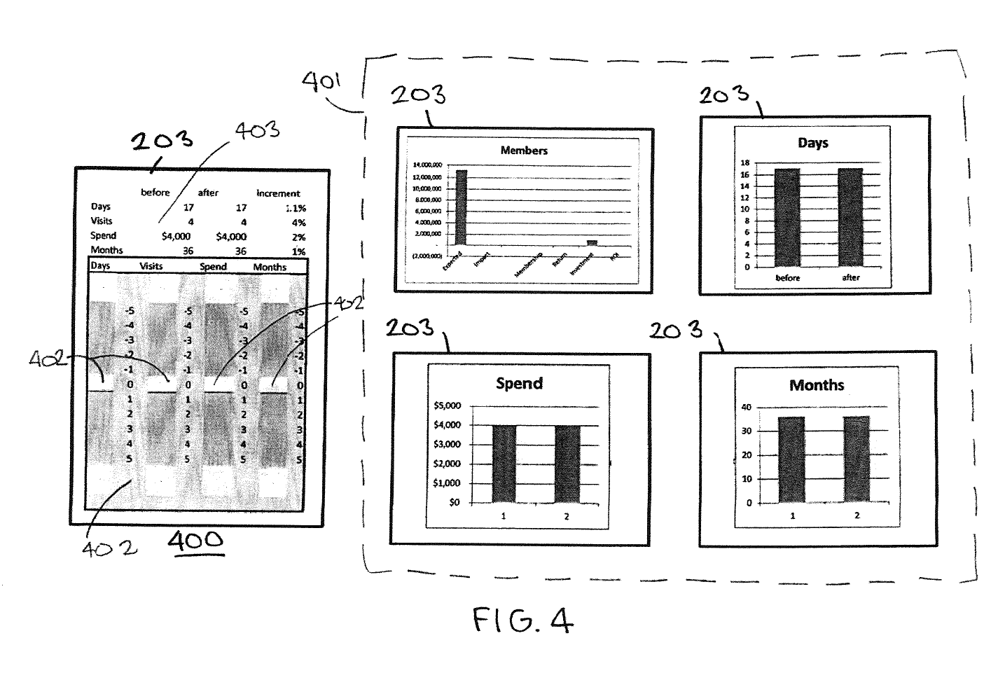

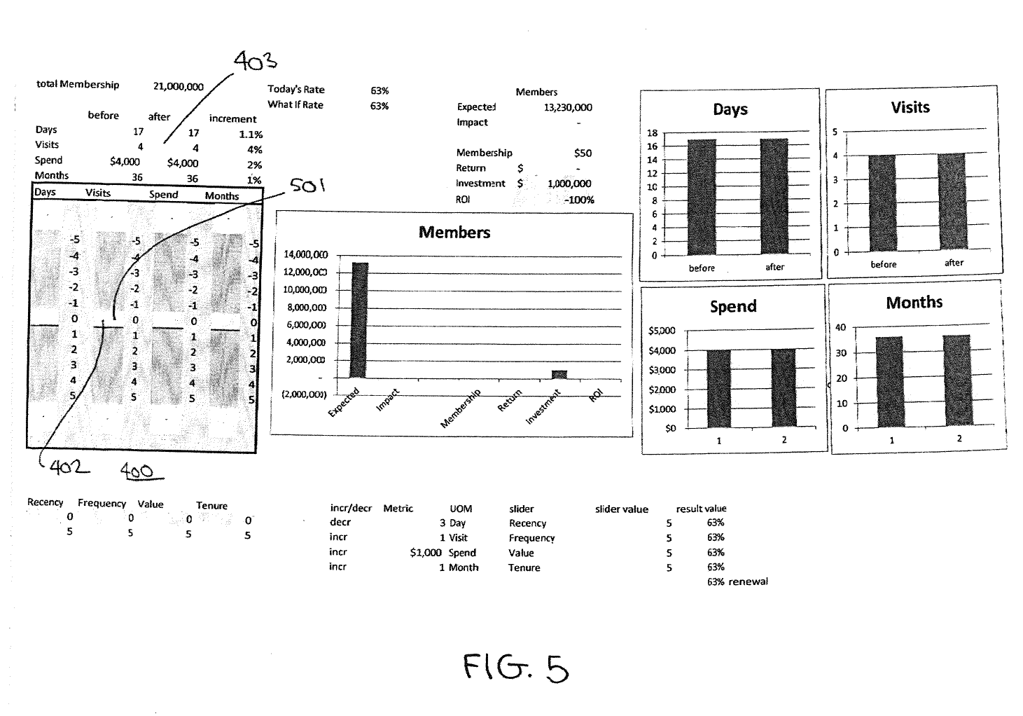

Referring again to FIG. 1, at block 101 the control circuit 201 presents, via at least one of the displays 203, at least one analytical result as corresponds to currently-selected values for at least two variables of the aforementioned analytical model. The control circuit 201 can also present graphical depictions regarding previous and/or present values for the variables themselves. In the illustrative example presented in FIG. 4, four of the aforementioned displays 203 (collectively denoted by reference numeral 401) each display respective past and present values for a corresponding variable.

At block 102, the control circuit 201 additionally forms and presents, via at least one of the displays 203, a virtual tool for each of at least two of the analytical model variables. These virtual tools are such that a user can selectively vary the aforementioned variables by movement of the corresponding virtual tool (referring, of course, to virtual movement as versus physical movement).

Referring again to FIG. 4, in this illustrative example of a user interface 400 as presented on one of the displays 203 includes four virtual tools comprising four virtual sliders 402. Each virtual slider 402 can be virtually moved vertically up or down by the user. By one approach, for example, the user can employ a cursor-control mechanism (such as a mouse or track pad) to select and so move the virtual slider 402. By another approach, in lieu of the foregoing or in combination therewith, when the display 203 comprises a touch-screen display as is known in the art the user can touch a particular one of the virtual sliders 402 and virtually move the latter by moving their fingertip in the desired vertical direction on the touch-screen display.

Each of the illustrated four virtual sliders 402 corresponds to a different analytical model variable. Left to right, these variables are labeled “days,” “visits,” “spend,” and “months.” Accordingly, virtually manipulating the virtual slider 402 on the far left as illustrated will cause corresponding changes to a variable corresponding to “days.” If desired, the virtual sliders 402 themselves and/or the vertical column in which the vertical slider 402 can selectively move can be color-coded in a manner that correlates to the particular variable that corresponds to that particular vertical slider 402.

In this illustrative example the four vertical sliders 402 are identical to one another including their various form factors, dimensions, and range of vertical movement. These teachings are flexible in this regard, however, and will readily accommodate other approaches if desired. For example, a particular one of the vertical sliders 402 could have a shorter or longer range of permitted virtual movement if desired.

By one approach each virtual slider 402 has a corresponding gauge to help the user have a sense of how far the slider 402 has been virtually moved from a nominal, initial position. In this illustrative example the gauge presents a visual indication of a present relative value of the corresponding variable (as versus an actual or absolute value of that variable). Accordingly, in this illustrative example each of the virtual tools employs the same relative scale. That relative scale presents the number “0” at a central, initial position, with the integers 1 through 5 presented below “0” and the negative integers −1 through −5 presented above “0.” So configured, virtually moving the virtual slider 402 downwardly will serve to increase the corresponding variable whereas moving the virtual slider 402 upwardly will decrease that variable.

By providing a relative scale that includes both positive values and negative values the virtual tool helps the user to intuitively understand the general result of manipulating one of the virtual sliders 402. In particular, that (in this particular example) moving a given one of the virtual sliders 402 downwardly will increase the value of that particular variable and moving that same virtual slider 402 upwardly will decrease the value of that particular variable. Accordingly, a user can make effective use of this virtual tool with little or no training

In this example the virtual tool 400 also includes, separate and apart from the virtual sliders 402, a presentation area that presents specific information regarding the actual values of the four variables in play. This specific information is shown, for each variable, to include a “before” value, an “after” value, and an “increment” value. As shown in FIG. 4, all of the virtual sliders 402 are at their nominal, initial position (i.e., when the values of the variables are as originally set when calculating corresponding results using the selected analytical model). Accordingly, the “after” values are all identical to the “before” values at this point as the user has not yet changed any of the variables.

In this illustrative example the control circuit 201 distinguishes between pre-selection of a particular virtual slider 402 setting and a selected setting. Pre-selection occurs when the user manipulates a given one of the virtual sliders 402 to a different position but has not yet confirmed that position as being selected. For example, but without intending any limitations regarding implementation details, a user can pre-select a new position for a virtual slider 402 by placing their finger on the desired virtual slider 402 and moving the virtual slider 402 by moving their finger on the touch-screen display without yet lifting that finger from the display. Upon then lifting their finger, the present position of the virtual slider 402 becomes selected.

FIG. 5 illustrates that a variety of analytical results can be presented that depend upon present settings of the aforementioned variables. These various analytical results can be presented as value fields in conjunction with a corresponding label. These teachings will also accommodate presenting such analytical results using any of a variety of other illustrative mechanisms, including, but not limited to, bar charts, line graphs, pie charts, radar charts, column charts, area charts, XY (scatter) charts, surface charts, doughnut charts, Geo map charts, and bubble charts, to note but a few relevant examples in these regards. These and other charts are well known in the art and require no further elaboration here.

FIG. 5 also illustrates that information regarding specific numeric values for the variables in play can be graphically depicted if desired. In this specific illustrative example the “before” and “after” values are shown in side-by-side comparison using corresponding column charts. Since the various values shown in FIG. 5 reflect initial conditions for the analytical model, the “before” and “after” values for all four variables are respectively identical.

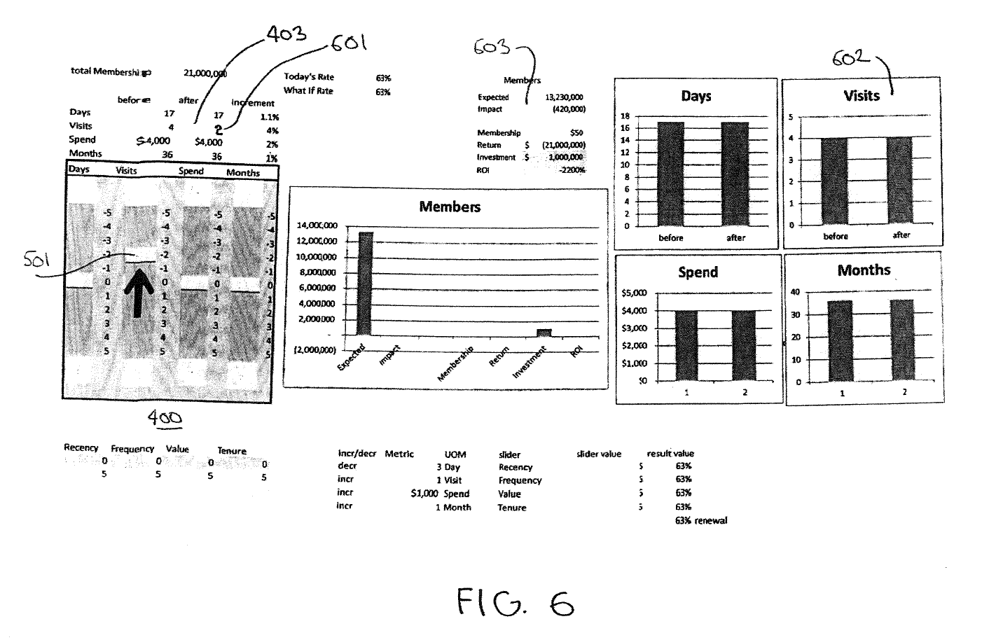

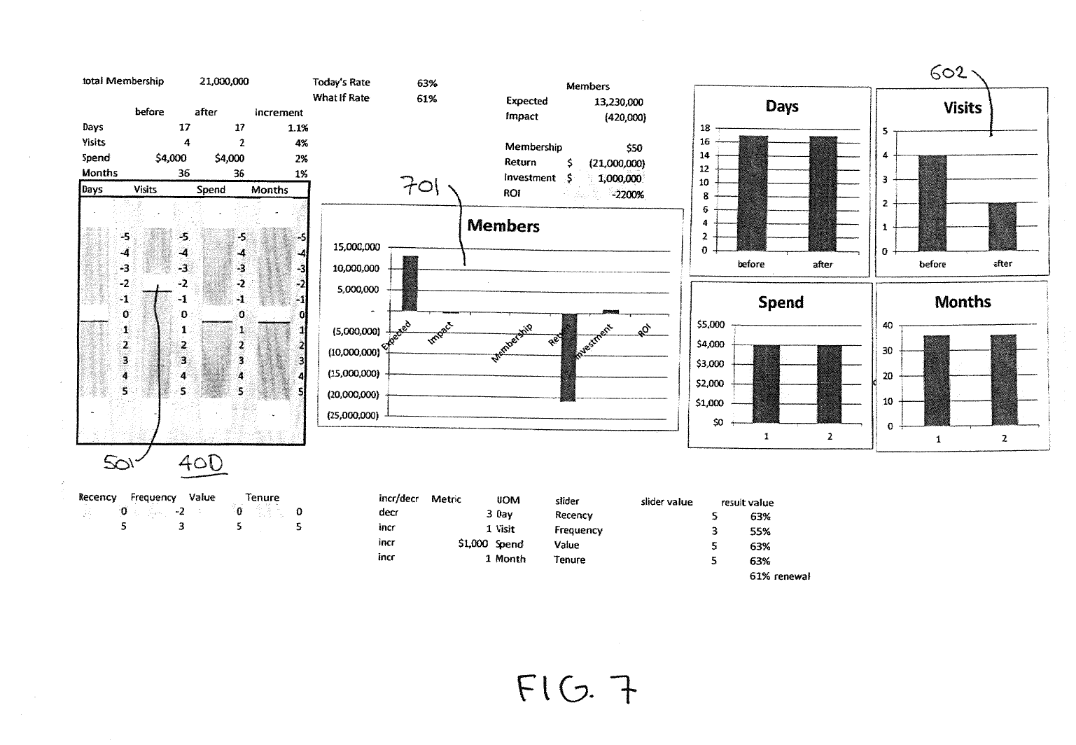

Referring to FIGS. 1, 5, and 6, at decision block 103 the control circuit 201 detects when the user pre-selects a new position for one of the virtual sliders 402. In this example the user pre-selects a new value for the “visits” variable by touching the touch-screen display in the area of the virtual slider 501 for that particular variable and moving that virtual slider 501 upwardly as represented in FIG. 6 by the arrow.

At block 104, the control circuit 201 can respond to this detection of a pre-selected position by presenting, in the aforementioned presentation area 403 that is, in this illustrative example, separate and apart from the virtual tool 400, a numeric value 601 that corresponds to the pre-selected position of the manipulated virtual slider 501 with respect to the aforementioned relative scale. In this case, by moving this virtual slider 501 upwardly, the user is reducing the value of the “visits” variable. In this particular example, this specifically means reducing the “visits” variable from a value of 4 to a value of 2.

Since the user has not yet selected this position for this particular virtual slider 501, however, the graphic depiction 602 for this “visits” variable remains presently unchanged. That said, however, these teachings will accommodate modifying other displayed results if desired. For example, in another presentation area 603 that provides specific values for expected membership, an impact upon that expected membership information and other related financial consequences is updated to reflect the calculated consequences of changing the “visits” variable as per the presently pre-selected position.

It will be understood that such analytical results can be displayed using as few or as many displays 203 as desired.

Referring now to FIGS. 1 and 7, at decision block 105 the control circuit 201 detects the user's selection of a particular pre-selected position for the virtual slider and responds by presenting, at block 106, a modification of at least one of the analytical results as corresponds to selection of the preselected position of the particular virtual tool. In the illustrated example, for instance, the analytical results presented in a “Members” information chart 701 are now significantly changed from what was previously displayed for this category of information due to re-processing of the analytical model using the new value for this particular variable.

With the user having now selected this particular position/value for the variable, in this illustrative example the control circuit 201 also now updates the graphic depiction 602 for this particular variable. In particular, the “after” value of this variable has been reduced as compared to its “before” value.

These teachings will readily accommodate a variety of modifications and alterations. As one example in these regards, each of a plurality of virtual tools can be presented to the user in a manner that separates one from the other rather than as a group as suggested by the illustrations. This might comprise, in one application setting, presenting the virtual tool for one variable on one display while presenting another virtual tool for another, different variable on a different display.

As another example in these regards, these teachings will accommodate chaining one variable to another if desired. This can be appropriate when one variable has some dependency upon another variable. In such a case, increasing one variable by moving its virtual tool can automatically cause the virtual tool for the chained variable to, for example, be decreased by some appropriate amount as the control circuit 201 calculates the appropriate proportional movement to present via the virtual tool for the chained variable.

As yet another example in these regards, by one approach the control circuit 201 will constrain the user to only being able to pre-select a single variable at a time. Or, if desired, the user may be permitted to pre-select more than one variable at a time before selecting a present position/value for any one of the pre-selected positions.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An apparatus comprising:
a memory having stored therein an analytical model that provides at least one analytical result as a function of at least two variables;
at least one display; and
a control circuit operably coupled to the memory and the at least one display, wherein the control circuit is configured to:
present, via the at least one display, the at least one analytical result as corresponds to currently-selected values for the at least two variables; and
form and present, via the at least one display, a virtual tool for each of the at least two variables, such that a user can selectively vary the variables by movement of the corresponding virtual tool.

2. The apparatus of claim 1 wherein the analytical model represents a retail sales enterprise.

3. The apparatus of claim 1 wherein the at least two variables comprise at least four variables.

4. The apparatus of claim 1 wherein the virtual tool comprises at least one of:
a virtual slider;
a virtual rotatable knob;
a virtual multi-position toggle switch;
an option button;
a scroll bar;
a spin bar;
a calendar control;
a calculator control;
a check box;
a combo box;
a geo map.

5. The apparatus of claim 1 wherein the control circuit is configured to present the virtual tool for each of the at least two variables such that the virtual tool presents a visual indication of a present relative value of the corresponding variable.

6. The apparatus of claim 5 wherein the control circuit is configured to present the visual indication of a present relative value of the corresponding variable for each of the virtual tools using a same relative scale.

7. The apparatus of claim 6 wherein the relative scale includes both positive values and negative values.

8. The apparatus of claim 5 wherein the control circuit is further configured to:
present, via the at least one display, in a presentation area separate and apart from the virtual tool, a numeric value corresponding to a pre-selected position of a particular one of the virtual tools with respect to the relative scale.

9. The apparatus of claim 8 wherein the control circuit is further configured to:
present, via the at least one display, a modification of at least one of the analytical results as corresponds to selection of the preselected position of the particular one of the virtual tools with respect to the relative scale.

10. The apparatus of claim 1 wherein the control circuit presents the at least one analytical result as corresponds to currently-selected values for the at least two variables by presenting at least one of:
a bar chart;
a line graph;
a pie chart;
a radar chart;
a column chart;
an area chart;
a x y (scatter) chart;
a surface chart;
a doughnut chart;
a geo map chart;
a bubble chart.

11. A method comprising:
by a control circuit that operably couples to at least one display and to a memory having stored therein an analytical model that provides at least one analytical result as a function of at least two variables:
presenting, via the at least one display, the at least one analytical result as corresponds to currently-selected values for the at least two variables; and
forming and presenting, via the at least one display, a virtual tool for each of the at least two variables, such that a user can selectively vary the variables by movement of the corresponding virtual tool.

12. The method of claim 11 wherein the analytical model represents a retail sales enterprise.

13. The method of claim 11 wherein the at least two variables comprise at least four variables.

14. The method of claim 11 wherein the virtual tool comprises at least one of:
a virtual slider;
a virtual rotatable knob;
a virtual multi-position toggle switch;
an option button;
a scroll bar;
a spin bar;
a calendar control;
a calculator control;
a check box;
a combo box;
a geo map.

15. The method of claim 11 wherein the control circuit presents the virtual tool for each of the at least two variables such that the virtual tool presents a visual indication of a present relative value of the corresponding variable.

16. The method of claim 15 wherein the control circuit presents the visual indication of a present relative value of the corresponding variable for each of the virtual tools using a same relative scale.

17. The method of claim 16 wherein the relative scale includes both positive values and negative values.

18. The method of claim 15 further comprising:
presenting, via the at least one display, in a presentation area separate and apart from the virtual tool, a numeric value corresponding to a pre-selected position of a particular one of the virtual tools with respect to the relative scale.

19. The method of claim 18 further comprising:
presenting, via the at least one display, a modification of at least one of the analytical results as corresponds to selection of the preselected position of the particular one of the virtual tools with respect to the relative scale.

20. The method of claim 11 wherein the control circuit presents the at least one analytical result as corresponds to currently-selected values for the at least two variables by presenting at least one of:
a bar chart;
a line graph;
a pie chart;
a radar chart;
a column chart;
an area chart;
a x y (scatter) chart;
a surface chart;
a doughnut chart;
a geo map chart;
a bubble chart.
